(19) United States
(12) Patent Application Publication
(10) Pub. No.: US 2015/0147434 A1
(43) Pub. Date: May 28, 2015

(54) Low Carbohydrate Bakery Items

(71) Applicant: Steck Wholesale Foods, Inc., North Sioux City, SD (US)

(72) Inventors: Craig Stanley, Dakota Dunes, SD (US); Doug Heck, Moville, IA (US)

(21) Appl. No.: 14/550,157

(22) Filed: Nov. 21, 2014

Related U.S. Application Data
(60) Provisional application No. 61/907,772, filed on Nov. 22, 2013.

(51) Int. Cl. A21D 13/04

(52) U.S. Cl. CPC A21D 13/04
USPC 426/18; 426/550

(57) ABSTRACT

The present invention relates to a low carbohydrate bakery item that does not contain any traditional flour, such as white or wheat flour. Instead, the bakery product has other ingredients that allow the bakery product to have similar characteristics, including taste and texture, as a traditional bakery item. The dough created for the bakery products has a consistency that allows it to be processed using traditional commercial bakery equipment, which typically cannot be used with other low carbohydrate bakery products because of the toughness of the dough.

### CROSS-REFERENCE(S) TO RELATED APPLICATION

This application claims a benefit of priority based on patent application 61/907,772, filed Nov. 22, 2013, the entire contents of which are hereby expressly incorporated by reference into the present application.

### BACKGROUND OF THE INVENTION

1. Field of the Invention

The present invention relates in general to the field of bakery items. More particularly, the present invention relates to traditional bakery items made without white or wheat flour.

2. Discussion of the Related Art

Traditionally, bakery goods, such as cookies, donuts, muffins, biscuits, English muffins, and other types of dough, contain white flour as a major ingredient. Many recipes relating to these types of products have remained unchanged for many years. However, as of the late, a greater understanding of the health consequences of eating these types of foods has resulted in many diets and other lifestyles aimed at minimizing the intake of carbohydrates. These types of diets can be tied to specific allergic reactions, as well as general weight loss goals. Needless to say, it is desirable to find ways to make bakery products that retain a taste and consistency similar to those that contain white flour, while minimizing the amounts of flour used. Many products have substituted at least some flour with high protein products or other additives to create a healthier alternative to traditional baked goods. For instance, see U.S. Pat. No. 8,088,427 and U.S. Patent Application Publications 2007/0160728, 2008/0020121, 2010/0255172, 2010/0297296, 2010/0297323, all of which are incorporated by reference.

For example, a number of products use large amounts of “vital” wheat gluten in production of dough. Unfortunately, addition of these additives can result in a dough that is too strong or bucky and difficult to handle during mixing, dividing, sheeting, and molding steps during the production of bakery goods. Also, high levels of protein such as soy protein may adversely affect flavor and give unacceptable volume and crumb grain properties.

What is needed therefore are bakery items that can emulate the positive qualities of traditional baking goods, while eliminating the white or wheat flour that is typically used in baking these goods.

A number of bakery items tout “reduced” flour, or being “flour free” products. One problem, however, with the majority of these products, is that the recipes are not well suited for the mass production of bakery goods on a commercial scale. Rather, these recipes are intended for production in small batches. Thus, attempting to mass produce these products can result in an inferior product. This undesirable bakery product often occurs as a result of the low carbohydrate dough's increased density and toughness, which is difficult to process using traditional commercial baking equipment.

Wheat gluten can be devitalized (or rendered non-vital) by the application of moisture, heat, pressure, shearing force, enzyme interaction, and/or chemical interaction. Devitalized gluten is characterized by the denaturation of its proteins, where structural changes occur and certain bonds are formed or broken. The denatured protein results in a devitalized gluten product that is non-cohesive and lacks viscoelasticity. Typical processing equipment used to carry out this devitalization includes extruders, jet-cookers, drum-driers, and boiling water tanks. For example, wheat gluten may undergo extrusion processing to produce a texturized product which does not exhibit the same viscoelastic properties of typical wheat gluten. In other words, the devitalized gluten does not form a rubbery and/or extensible dough when hydrated. Devitalized wheat gluten preferably comprises at least about 60% by weight protein, and more preferably at least about 70% by weight (N×6.25, dry basis). Examples of devitalized wheat gluten for use with the present invention include but are not limited to: Wheatex™ 16, Wheatex™ 120. Wheatex™ 240, Wheatex™ 751, Wheatex™ 1501, Wheatex™ 2120, Wheatex™ 2240, Wheatex™ 2400, Wheatex™ 3000, Wheatex™ 6000, Wheatex™ 6500, and Wheatex™ RediShred 65 available from MGP Ingredients, Inc. of Atchison, Kans. These Wheatex™ products may contain malt or caramel.

Wheat gluten is a binary mixture of gliadin and glutenin. These protein components can be separated by alcohol fractionation or by using a non-alcoholic process (as disclosed in U.S. Pat. No. 5,610,277) employing the use of organic acids. Gliadin is soluble in 60-70% alcohol and comprises monomeric proteins with molecular weights ranging from 30,000 to 50,000 daltons. These proteins are classified as alpha-, beta-, gamma-, and omega-gliadins depending on their mobility during electrophoresis at low pH. Gliadin is primarily responsible for the extensible properties of wheat gluten. Glutenin is the alcohol insoluble fraction of gluten and contributes primarily to the elastic or rubbery properties of wheat gluten. Glutenin is a polymeric protein stabilized with inter-chain disulfide bonds and made up of high-molecular weight and low molecular weight subunits. Generally, glutenin exhibits a molecular weight exceeding one million daltons. Preferred fractionated wheat protein products comprise at least about 85% by weight protein, and more preferably at least about 90% by weight for gliadin and about 75% by weight protein, and more preferably at least about 80% by weight for glutenin, all proteins expressed on N×6.25, dry basis.

In addition to comprising a quantity of flour (particularly wheat flour), preferred bakery products or other food products (including dough) contain from about 1-150 baker's percent of a first proteinaceous ingredient (preferably from about 5-60 baker's percent) comprising at least about 70% by weight protein and a second proteinaceous ingredient (preferably different from the first ingredient) selected from the group consisting of:

a) between about 05-100 baker's percent of a wheat protein isolate product;

b) between about 05-100 baker's percent of a wheat protein concentrate product;

c) between about 05-100 baker's percent of a devitalized wheat gluten product;

d) between about 05-20 baker's percent of a fractionated wheat protein product;

e) between about 05-20 baker's percent of a deamidated wheat gluten product;

f) between about 05-30 baker's percent of a hydrolyzed wheat protein product; and

g) any combination of ingredients (a)-(f).

As used herein, the term “baker's percentage” means the weight percent taken on a flour basis, with the weight of flour present in the product being 100%. Furthermore, all protein weight percentages expressed herein are on a N×6.25, dry basis, unless otherwise specified.

Wheat protein isolates are generally derived from wheat gluten by taking advantage of gluten's solubility at alkaline or acidic pH values. Wheat gluten is soluble in aqueous solutions with an acidic or alkaline pH and exhibits a classical “U-shaped” solubility curve with a minimum solubility or isoelectric point at pH 6.5-7.0. By dissolving the gluten, proteins can be separated from non-protein components by processes like filtration, centrifugation, or membrane processing followed by spray drying. Alternatively, wet gluten from wet processing of wheat flour can be repeatedly kneaded, water washed, and dewatered to get rid of contaminating starch and other non-protein components, and subsequently flash dried. These techniques yield a wheat protein isolate product with elevated protein content, at least about 85% by weight, more preferably at least about 90% by weight (on an N×6.25, dry basis). Wheat protein isolates in general are less elastic but more extensible than wheat gluten. Examples of preferred wheat protein isolates include Arise™ 3000, Arise™ 5000, Arise™ 6000, Pasta PoWer, and Arise™ 8000 and their blends available from MGP Ingredients, Inc., Atchison, Kans.

### SUMMARY AND OBJECTS OF THE INVENTION

By way of summary, the present invention is directed to bakery items that do not contain white or wheat flour, but that have similar taste, texture, and handling properties as traditional bakery items. As used herein, the term “low carbohydrate bakery product” refers to compositions which contain higher protein and lower carbohydrate amounts relative to traditional bakery products.

As mentioned above, a primary object of the invention is to provide a low carbohydrate bakery product. This product is created using wheat gluten, oat flour, vegetable oil, glycerin, water, instant yeast, ParProAm™, Natax™ 2.2, flax seed meal, Fibersol® 2, oat fiber-1, action gum, and salt. In an alternative embodiment, the product is created using wheat gluten, vegetable oil, glycerin, water, instant yeast, ParProAm™, Natax™ 2.2, flax seed meal, Fibersol® 2, oat fiber-1, action gum, and salt. These ingredients are not all added simultaneously, but rather the mixing occurs in several stepped processes. This ensures that the dough reaches the appropriate consistency, because some ingredients affect the consistency and formulation of the dough. For instance, the fiber ingredients are known to absorb as much water as possible, and thus they must be added later on in the mixture. With a formulation such as this, the fiber may need to be pre-hydrated to avoid competition for the existing water. Adding fiber ingredients initially will result in a tough dough that does not have the right constituency. Salt has similar tendencies, and if it added too early in the process, it will cause the dough to toughen such that it is not workable, especially with commercial baking equipment.

Another object of the invention is to provide the exact proportions of each ingredient required to create the low carbohydrate bakery item. To achieve the desired results, in one embodiment the following amounts of materials should be readily available to be mixed: 120 parts vital wheat gluten, 40 parts oat flour, 20 parts vegetable oil, 16 parts vinegar, parts glycerin, 205 parts water, 58 parts instant yeast, 0.1 parts ParProAm™, 10 parts Natax™ 2.2, 140 parts flax seed meal, 88 parts Fibersol® 2, 80 parts oat fiber-1, 185 parts water, parts action gum, 8 parts salt, and 20 parts water. In an alternative embodiment, the following amounts of material should be readily available to be mixed: 20 parts vegetable oil, 16 parts vinegar, 28 parts glycerin, 150 parts water, 40 parts instant yeast, 0.1 parts ParProAm™, 3.4 parts Natax™ 2.2, 90 parts flax seed meal, 93 parts Fibersol® 2, 90 parts oat fiber-1, 140 parts water, 0.6 parts action gum, 8 parts salt, 50 parts whey protein isolate, 5 parts vegetable oil, 1.5 parts flavor masking, 5.86 parts baking powder, and 30 parts water.

Another object of the invention is to provide a means of mass producing a low carbohydrate bakery product. This is difficult because the mixing process for dough without flour takes much longer to achieve the same consistency of dough with flour. Without sufficient mixing, the dough will be too difficult to process through common bakery machinery. Obviously, to be mass marketed and produced, excessive mixing times must be eliminated and the dough must be of the appropriate density and workability to be processed by bakery machines.

To make the dough, the first step is to combine a first group of ingredients, including vital wheat gluten and oat flour in a mixer. To mass produce the low carbohydrate bakery item, it should be mixed in a commercial sized mixer. A second group of wet ingredients, including vegetable oil, vinegar, and glycerin are mixed together, then added to the first group of ingredients. A slurry is created with a third group of ingredients including water, instant yeast, ParProAm, and Natax 2.2. Once the slurry has been created, it is added to the first and second groups of ingredients at a first mixing speed for approximately one minute. The mixing speed is turned up to a second, faster mixing speed for approximately twelve minutes, which results in the formation of an initial mixture. Next, a fourth set of ingredients are added to the initial mixture. The fourth group of ingredients include flax seed meal, oat fiber, and Fibersol 2. A second slurry is created by combining water and action gum. In an alternative embodiment, half of the flax seed meal is added to the fourth set of ingredients, and half of the flax seed meal is added to the second slurry. Once the second slurry has been created, it is added to the initial mixture and the fourth group of ingredients, and mixed on the first mixing speed for approximately one minute. The mixing speed is turned up to the second, faster mixing speed for approximately twelve minutes to form an intermediate mixer. In another embodiment, a longer mixing time of approximately twenty minutes is used on the second, faster mixing spend. Finally, salt and water are added to the intermediate mixture, and mixed on the first mixing speed for approximately 30 seconds. The mixing speed is turned up to the second, faster mixing speed for approximately 3.5 minutes to form the low carbohydrate bakery product dough.

Another object of the invention is to take the made dough and commercially prepare it and bake it. After the dough is created, the first step is to relax the dough so that the dough's elasticity is such that it can be passed through a dough pump. Next, the relaxed dough is pumped through the dough pump such that the dough is arranged in a straight line. At this point, the dough is ready to be divided into equal sized, individual portions. The individual sized portions of dough are covered in corn meal, and subjected to high heat and humidity which starts yeast activation and fermentation. Finally, the dough is baked in an oven.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates an industrial sized commercial bakery mixer in which the dough is mixed;

FIG. 2 illustrates a vat containing the mixed dough, where the dough rests before it is pumped through the dough pump;

FIG. 3 illustrates a dough pump with dough being pumped to a conveyor,

FIG. 4 illustrates a dough separator, where the dough is collected from the conveyor and separated into individual-sized portions;

FIG. 5 illustrates a plurality of conveyor cups containing individual-sized portions of dough;

FIG. 6 illustrates the individual-sized portions of dough after the yeast has activated and the dough has risen;

FIG. 7 illustrates a flow chart of the method of creating the inventive low-carbohydrate bakery dough;

FIG. 8A illustrates a flow chart of the first set of steps for a method of making the inventive low-carbohydrate bakery item;

FIG. 8B is a continuation of the flow chart of FIG. 8a that illustrates an additional set of steps for a method of making the inventive low-carbohydrate bakery item; and

FIG. 9 illustrates an ingrediator where an ingredients are mixed before being pumped to the industrial sized commercial bakery mixer of FIG. 1.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word mixed, combine, or terms similar thereto are often used. They are not limited to one type of mixing but can include any means of combining multiple ingredients together as would be recognized as being equivalent by those skilled in the art.

### DETAILED DESCRIPTION

The present invention and the various features and advantageous details thereof are explained more fully with reference to the non-limiting embodiments described in detail in the following description.

### 1. System Overview

Initially, testing began for both buttermilk biscuit and English muffin tests. After testing the muffin, the mix time was extremely long because it had so much gluten and strength. The mix time was reduced because the dough was not releasing gas in the oven like conventional baked goods. Additionally, a reducing agent called Protease Enzyme was added. Protease Enzyme breaks down protein bonds and renders them unrepairable through the baking process. Natax™ was also added as a reducing agent, but it did not cause harm to the protein bond and the protein repairs itself prior to baking. The proper mixture of both reducing agents is needed to create the proper strength and elasticity. Also, the amount of gluten was reduced in the mix. In turn, this led to a reduction of protein or strength in the formula.

The mix times of the dough were decreased from 65 minute to 45 minutes. A standard English muffin is mixed in about 17 minutes and the goal has been to get the low-carbohydrate English muffin mix time reduced to 20 minutes to improve efficiency. The initial tests were taking 65 minutes to mix, which was not efficient, so some reductions in the mix were made.

The dough itself needed to be more relaxed so that standard, commercial bakery machines could process the product. For instance, the dough needed to be of a consistency that allowed it to go through a dough pump. The dough must be very soft flaccid, and relaxed to easily be pumped through the dough pump.

Once the dough comes out of the pump, it goes onto a belt, which carries the dough to the divider unit. In the initial test, the pump could not pump the new dough nor would the divider run it as the dough was too stiff and firm. The automated divider is inline after the dough pump and has a hopper on top and divides the dough into the proper weighted piece prior to proofing. In typical operation, after dividing, the dough balls are enrobed in corn meal automatically and then deposited on the proofer or proof box conveyor cups.

The mix time was reduced down to 40 minutes, which produced a product that resembled an English muffin. Still, the inside of the English muffin was very wet because the dough was not proofing properly and still needed to relax after proofing. Proofing is the stage after dividing where the dough is exposed to high heat and humidity to start the yeast activation process. These conditions result in the start of fermentation of the dough.

Once on the conveyor cups, the dough travels into the proof box with high heat and humidity for 30 minutes to activate the yeast. The dough raises slightly in preparation for the bake process. The original low carbohydrate formulation would not scale properly nor proof properly. It would not release the gas created by the yeast at first until reducing agents were added and the dough relaxed more at the mixer.

Once proofed, the cups deposit the dough automatically onto the griddle or baking surface. Initially, the low carbohydrate product was proofed much higher because the dough would not relax and release the gas. When it baked, it baked like a ball and not like a typical English muffin that is shaped like a hockey puck. The mix times were reduced by adding a reducing agent called Natax™, and Protease® Enzymes was added to break down protein. Reducing ingredients are also used that hold onto water so the water will be released in the oven and dry out more.

### 2. Detailed Description

In one embodiment, the present invention provides a low carbohydrate bakery product. For example, the low carbohydrate bakery product may be a low carbohydrate English muffin. This bakery product is formulated of ingredients, absent conventional flour, such as white or wheat flour, that result in a finished product similar in taste and texture to a traditional bakery product that contains flour. Instead, a small amount of oat flour is used. Additionally, the present invention includes a dough that possesses characteristics that allow it to be mass produced using common commercial bakery equipment. It should be noted that the order in which ingredients are combined is important to the proper formation of dough, because many of the ingredients compete for available water. Without mixing in the proper order, there is risk that the consistency of dough will not be correct, and this will have an effect on the taste, consistency, and workability of the dough.

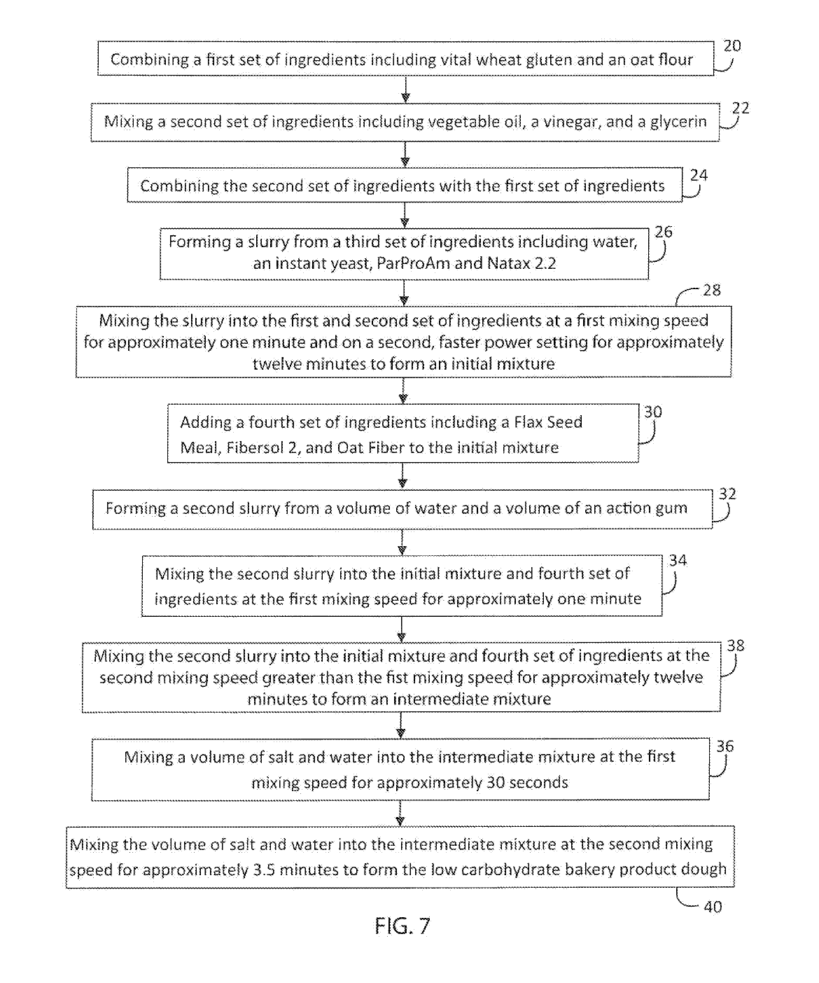

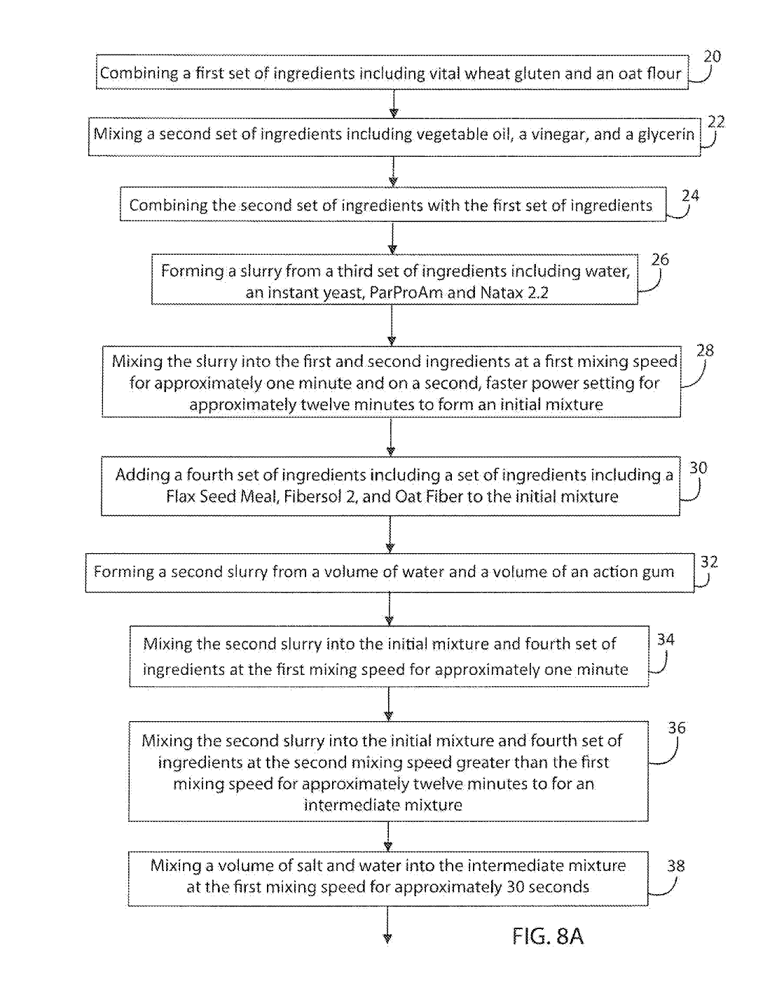

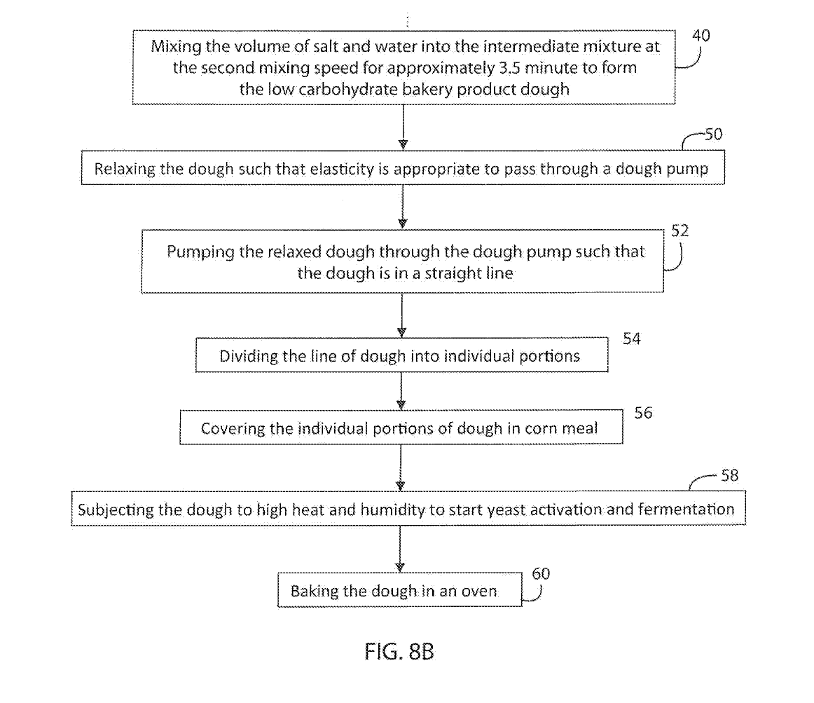

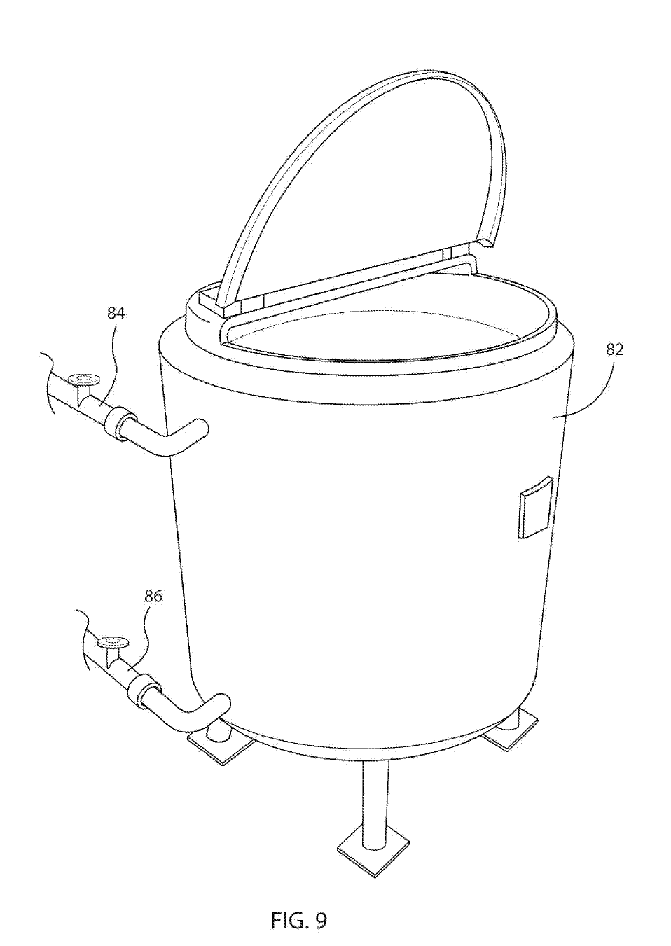

The method of making a low carbohydrate bakery item in accordance with the present invention begins with creating the dough is shown in FIGS. 7, 8A, and 8B. In one embodiment of the present invention, the low carbohydrate bakery item is an English muffin.

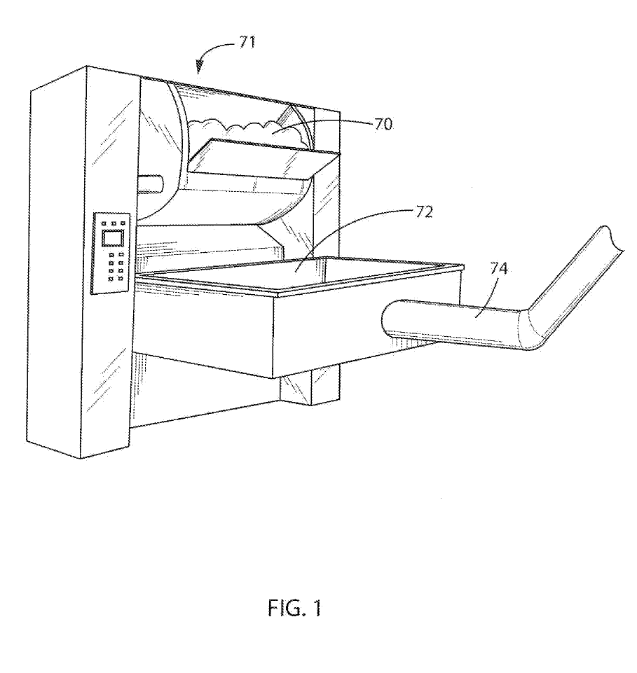

As shown in the flow charts of FIGS. 7 and 8A, the preferred first step of one method of making a low carbohydrate English muffin is to mix a first set of ingredients in a mixer (20). The first set of ingredients may include vital wheat gluten and oat flour. Alternatively, the first set of ingredients may include only vital wheat gluten. In one embodiment of this invention, the dough 70 is mass produced, and thus this set of ingredients may be mixed in a commercial-sized mixer until they are combined. For instance, the first set of ingredients may be mixed in an industrial sized commercial bakery mixer 71 as shown in FIG. 1.

At another step (22) of the method, which may occur at the same time as the first step, a second set of ingredients are combined. The second set of ingredients is preferably liquid and may include vegetable oil, vinegar, and glycerin. To combine the liquids of the second set of ingredients, they are preferably added to an ingrediator 82 as shown in FIG. 9 and combined. The ingrediator 82 is used to mix the liquids contained therein until they are evenly distributed. The ingrediator 82 may be in fluid connection with the bakery mixer 71 that contains the first set of ingredients. For instance, as shown in FIG. 9, the ingrediator 82 has pipes 84, 86 that can supply the ingredients to or from the mixer 71.

At a next step (24) of the method, once the liquids of the second set of ingredients are fully and evenly distributed, they are combined with the first set of ingredients in the mixer and combined therewith.

At the next step (26) of the method, a slurry is created in the ingrediator 82 from a third set of ingredients. The ingrediator 82 is more efficient at dispersion of the various ingredients into the water of the slurry. In the ingrediator 82, the third set of ingredients may include water that is combined with instant yeast, ParProAm™, and Natax™ 2.2 to create the slurry. Once the instant yeast, ParProAm™, and Natax™ 2.2 are distributed throughout the water, and the slurry is complete, it is directly combined with the mixture contained within the commercial mixer in the sixth step. The slurry should then be mixed in to the commercial mixer slowly, initially on a low or slow speed mixing setting for approximately 1 minute. In the next step (28), the speed should then be sped up to a second mixing setting, which is higher than the initial speed, for approximately 12 minutes.

Next, a fourth set of ingredients should be added to the commercial mixer (30). The fourth set of ingredients may include flax seed meal, Fibersol® 2, and oat fiber-1, which should be placed into the commercial-sized mixer, with the previously disclosed ingredients and slurry that have already been mixed together. In an alternative embodiment, only half of the flax seed meal is included in the fourth set of ingredients.

Subsequently, a second slurry may be created by adding water to an action gum in the ingrediator 82 (32). In the alternative embodiment, the remaining half of the flax seed meal is also added to the ingrediator 82 to pre-hydrate some of the fiber, which can reduce the overall mix time by approximately 1 minute. Once the action gum and flax seed meal are dispersed throughout the water, the second slurry is then combined with the contents of the commercial mixer (34). However, it should be noted that in an alternate embodiment, the action gum may be removed entirely from the second slurry. In which case, the water is piped directly from the ingrediator 82 into the mixer. The second slurry is then mixed into the contents of the mixer, initially on a low or slow speed mixing setting for 1 minute. The speed should then be sped up to a high mixing setting, which is higher than the initial speed, for approximately 10 minutes (36). In the alternative embodiment, the mix time is increased to approximately 20 minutes.

Finally, salt is added to the mixture contained within the commercial mixer 71. Preferably, salt is not added until the end, because salt can make the dough tough if added to the mixture earlier in the process. An additional amount of water is added into the ingrediator 82, which pipes the water into the mixer. The salt and water should initially be mixed in on a slow speed setting for 30 seconds (38). The speed should then be sped up to a high mixing setting for approximately 3 minutes and 30 seconds (40), as best seen in the flow chart illustrated in FIG. 8B. As will be appreciated, the steps shown in the flow chart in FIG. 8A continue into the steps shown in the flow chart of FIG. 8B.

Alternate embodiments of formula for creating a dough 70 for a low carbohydrate English muffin are included in Tables I-VIII below, including specific quantities of ingredients, all which are considered well within the scope of the current invention.

TABLE I

| | Approximate | | |
|---|---|---|---|
| | Preferred | Approximate | |
| Ingredient | Range of | Preferred | |
| Name | Amount (lbs.) | Amount (lbs.) | Instruction |
| 1^{st} Mix | | | |
| Vital Wheat | 60-80 | 70 | Add to mixer |
| Gluten | | | |
| Oat Flour | 10-30 | 20 | Add to mixer |
| Vegetable Oil | 5-15 | 10 | Add to ingrediator |
| Vinegar | 4-12 | 8 | Add to ingrediator |
| Glycerin | 0.0-18 | 14 | Add to ingrediator |
| | | | All of the above |
| | | | ingredients are mixed |
| | | | together. |
| Slurry | | | |
| Water | 175-200 | 190 | Add water to the |
| | | | following three |
| | | | ingredients to make |
| | | | slurry |
| Instant Yeast | 15-25 | 20 | |
| ParProAm | 0.0-1.0 | 0.2 | |
| Natax 2.2 | 0.0-3.0 | 2.4 | |
| | | | Once ingredients have |
| | | | dispersed into water to |
| | | | create slurry, slurry is |
| | | | automatically added |
| | | | through the top of the |
| | | | mixer |
| 2^{nd} Mix | | | |
| Flax Seed Meal | 50-80 | 70 | Add to mixer |
| Fibersol 2 | 35-50 | 44 | Add to mixer |
| Oat Fiber-1 | 30-50 | 30 | Add to mixer |
| (light) | | | |
| Slurry | | | Add water to the |
| | | | action gum to make |
| | | | slurry |
| Water | 10-30 | 20 | Add to ingrediator |
| Action gum | 0.0-0.5 | 0.3 | Add to mixer |
| | | | Once ingredients have |
| | | | dispersed into water to |
| | | | create slurry, slurry is |
| | | | automatically added |
| | | | through the top of |
| | | | mixer. |
| 3^{rd} Mix | | | |
| Salt | 2-6 | 4 | Add to mixer |
| Water | 2-10 | 5 | Add to ingrediator |
| | | | Mix the salt and water |
| | | | into the dough in the |
| | | | mixer. |

TABLE II

| | Approximate | | |
|---|---|---|---|
| | Preferred | Approximate | |
| Ingredient | Range of | Preferred | |
| Name | Amount (lbs.) | Amount (lbs.) | Instruction |
| 1^{st} Mix | | | |
| Vital Wheat | 50-70 | 60 | Add to mixer |
| Gluten | | | |
| Oat Flour | 10-30 | 20 | Add to mixer |
| Vegetable Oil | 5-15 | 10 | Add to ingrediator |
| Vinegar | 4-12 | 8 | Add to ingrediator |
| Glycerin | 0.0-18 | 14 | Add to ingrediator |
| Slurry | | | |
| Water | 150-200 | 175 | Add water to the |
| | | | following three |
| | | | ingredients to make |
| | | | slurry |
| Instant Yeast | 15-25 | 20 | |
| ParProAm | 0.0-1.0 | 0.1 | |
| Natax 2.2 | 0.0-3.0 | 1.2 | |
| | | | Once ingredients have |
| | | | dispersed into water to |
| | | | create slurry, slurry is |
| | | | automatically added |
| | | | through the top of the |
| | | | mixer |
| 2^{nd} Mix | | | |
| Flax Seed Meal | 50-80 | 70 | Add to mixer |
| Fibersol 2 | 35-50 | 44 | Add to mixer |
| Oat Fiber-1 | 30-50 | 40 | Add to mixer |
| (light) | | | |
| Slurry | | | Add water to the |
| | | | action gum to make |
| | | | slurry |
| Water | 10-30 | 20 | Add to ingrediator |
| Action gum | 0.0-0.5 | 0.3 | Add to mixer |
| | | | Once ingredients have |
| | | | dispersed into water to |
| | | | create slurry, slurry is |
| | | | automatically added |
| | | | through the top of |
| | | | mixer |
| 3^{rd} Mix | | | |
| Salt | 2-6 | 4 | Add to mixer |
| Water | 2-10 | 5 | Add to ingrediator |
| | | | Mix the salt and water |
| | | | into the dough in the |
| | | | mixer. |

TABLE III

| | Approximate | | |
|---|---|---|---|
| | Preferred | Approximate | |
| Ingredient | Range of | Preferred | |
| Name | Amount (lbs.) | Amount (lbs.) | Instruction |
| 1^{st} Mix | | | |
| Vital Wheat | 50-70 | 60 | Add to mixer |
| Gluten | | | |
| Oat Flour | 10-30 | 20 | Add to mixer |
| Vegetable Oil | 5-15 | 10 | Add to ingrediator |
| Vinegar | 4-12 | 8 | Add to ingrediator |
| Glycerin | 0.0-18 | 14 | Add to ingrediator |
| Slurry | | | |
| Water | | TBD | Add water to the |
| | | | following three |
| | | | ingredients to make |
| | | | slurry |
| Instant Yeast | 15-25 | 20 | |
| ParProAm | 0.0-1.0 | 0.2 | |
| Natax 2.2 | 0.0-3.0 | 2.4 | |
| | | | Once ingredients have |
| | | | dispersed into water to |
| | | | create slurry, slurry is |
| | | | automatically added |
| | | | through the top of the |
| | | | mixer |
| 2^{nd} Mix | | | |
| Flax Seed Meal | 50-80 | 70 | Add to mixer |
| Fibersol 2 | 35-50 | 44 | Add to mixer |
| Oat Fiber-1 | 30-50 | 40 | Add to mixer |
| (light) | | | |
| Slurry | | | Add water to the |
| | | | action gum to make |
| | | | slurry |
| Water | 10-30 | 20 | Add to ingrediator |
| Action gum | 0.0-0.5 | 0.3 | Add to mixer |
| | | | Once ingredients have |
| | | | dispersed into water to |
| | | | create slurry, slurry is |
| | | | automatically added |
| | | | through the top of |
| | | | mixer |
| 3^{rd} Mix | | | |
| Salt | 2-6 | 4 | Add to mixer |
| Water | 2-10 | 5 | Add to ingrediator |
| | | | Mix the salt and water |
| | | | into the dough in the |
| | | | mixer |

TABLE IV

| | Approximate | | |
|---|---|---|---|
| | Preferred | Approximate | |
| Ingredient | Range of | Preferred | |
| Name | Amount (lbs.) | Amount (lbs.) | Instruction |
| 1^{st} Mix | | | |
| Vital Wheat | 110-130 | 120 | Add to mixer |
| Gluten | | | |
| Oat Flour | 30-50 | 40 | Add to mixer |
| Vegetable Oil | 15-25 | 20 | Add to ingrediator |
| Vinegar | 12-24 | 16 | Add to ingrediator |
| Glycerin | 20-30 | 28 | Add to ingrediator |
| Slurry | | | |
| Water | 130-160 | 150 | Add water to the |
| | | | following three |
| | | | ingredients to make |
| | | | slurry |
| Instant Yeast | 30-50 | 40 | |
| ParProAm | 0.0-1.0 | 0.2 | |
| Natax 2.2 | 0.0-3.0 | 2.4 | In 22 tabs |
| | | | Once ingredients have |
| | | | dispersed into water to |
| | | | create slurry, slurry is |
| | | | automatically added |
| | | | through the top of the |
| | | | mixer |
| 2^{nd} Mix | | | |
| Flax Seed Meal | 130-150 | 140 | Add to mixer |
| Fibersol 2 | 70-100 | 88 | Add to mixer |
| Oat Fiber-1 | 70-100 | 80 | Add to mixer |
| (light) | | | |
| Slurry | | | Add water to the |
| | | | action gum to make |
| | | | slurry |
| Water | 200-275 | 240 | Add to ingrediator |
| Action gum | 0.0-1.0 | .6 | Add to mixer |
| | | | Once ingredients have |
| | | | dispersed into water to |
| | | | create slurry, slurry is |
| | | | automatically added |
| | | | through the top of |
| | | | mixer |
| 3^{rd} Mix | | | |
| Salt | 4-10 | 8 | Add to mixer |
| Water | 5-15 | 10 | Add to ingrediator |
| | | | Mix the salt and water |
| | | | into the dough in the |
| | | | mixer |

TABLE V

| | Approximate | | |
|---|---|---|---|
| | Preferred | Approximate | |
| Ingredient | Range of | Preferred | |
| Name | Amount (lbs.) | Amount (lbs.) | Instruction |
| 1^{st} Mix | | | |
| Vital Wheat | 110-130 | 120 | Add to mixer |
| Gluten | | | |
| Oat Flour | 30-50 | 40 | Add to mixer |
| Vegetable Oil | 15-25 | 20 | Add to ingrediator |
| Vinegar | 12-24 | 16 | Add to ingrediator |
| Glycerin | 20-30 | 28 | Add to ingrediator |
| Slurry | | | |
| Water | 175-225 | 200 | Add water to the |
| | | | following three |
| | | | ingredients to make |
| | | | slurry |
| Instant Yeast | 40-60 | 48 | |
| ParProAm | 0.0-1.0 | 0.1 | |
| Natax 2.2 | 2.0-5.0 | 3.6 | |
| | | | Once ingredients have |
| | | | dispersed into water to |
| | | | create slurry, slurry is |
| | | | automatically added |
| | | | through the top of the |
| | | | mixer |
| 2^{nd} Mix | | | |
| Flax Seed Meal | 130-150 | 140 | Add to mixer |
| Fibersol 2 | 70-100 | 88 | Add to mixer |
| Oat Fiber-1 | 70-100 | 80 | Add to mixer |
| (light) | | | |
| Slurry | | | Add water to the |
| | | | action gum to make |
| | | | slurry |
| Water | 150-225 | 190 | Add to ingrediator |
| Action gum | 0.0-1.0 | 0.6 | Add to mixer |
| | | | Once ingredients have |
| | | | dispersed into water to |
| | | | create slurry, slurry is |
| | | | automatically added |
| | | | through the top of |
| | | | mixer |
| 3^{rd} Mix | | | |
| Salt | 4-10 | 8 | Add to mixer |
| Water | 5-1.5 | 20 | Add to ingrediator |
| | | | Mix the salt and water |
| | | | into the dough in the |
| | | | mixer |

TABLE VI

| | Approximate | | |
|---|---|---|---|
| | Preferred | Approximate | |
| Ingredient | Range of | Preferred | |
| Name | Amount (lbs.) | Amount (lbs.) | Instruction |
| 1^{st} Mix | | | |
| Vital Wheat | 110-130 | 120 | Add to mixer |
| Gluten | | | |
| Oat Flour | 30-50 | 40 | Add to mixer |
| Vegetable Oil | 15-25 | 20 | Add to ingrediator; |
| | | | mix 2 minutes on low |
| Vinegar | 12-24 | 16 | Add to ingrediator |
| Glycerin | 20-35 | 28 | Add to ingrediator |
| Slurry | | | |
| Water | 130-160 | 205 | Add water to the |
| | | | following three |
| | | | ingredients to make |
| | | | slurry |
| Instant Yeast | 40-65 | 58 | |
| ParProAm | 0.0-1.0 | 0.1 | |
| Natax 2.2 | 2.0-8.0 | 6 | |
| | | | Mix slurry and above |
| | | | ingredients on low for |
| | | | 1 minute; then on |
| | | | high for 12 minutes |
| 2^{nd} Mix | | | |
| Flax Seed Meal | 130-150 | 140 | Add to mixer |
| Fibersol 2 | 70-100 | 88 | Add to mixer |
| Oat Fiber-1 | 70-100 | 80 | Add to mixer |
| (light) | | | |
| Slurry | | | Add water to the |
| | | | action gum to make |
| | | | slurry |
| Water | 150-200 | 185 | Add to ingrediator |
| Action gum | 0.0-1.0 | 0.6 | Add to mixer |
| | | | Mix slurry with 2^{nd} |
| | | | mix for 1 minute on |
| | | | low, then 10 minutes |
| | | | on high |
| 3^{rd} Mix | | | |
| Salt | 4-10 | 8 | Add to mixer |
| Water | 5-15 | 20 | Add to ingrediator |
| | | | Mix 3^{rd} mix on low |
| | | | for 30 seconds, then |
| | | | 3.5 minutes on high |

TABLE VII

| | Approximate | | |
|---|---|---|---|
| | Preferred | Approximate | |
| Ingredient | Range of | Preferred | |
| Name | Amount (lbs.) | Amount (lbs.) | Instruction |
| 1^{st} Mix | | | |
| Vital Wheat | 110-130 | 120 | Add to mixer |
| Gluten | | | |
| Oat Flour | 30-50 | 40 | Add to mixer |
| Vegetable Oil | 15-25 | 20 | Add to ingrediator; |
| | | | mix 2 minutes on low |
| Vinegar | 12-24 | 16 | Add to ingrediator |
| Glycerin | 0.0-1.0 | 0.0 | Add to ingrediator |
| Slurry | | | |
| Water | 175-225 | 205 | Add water to the |
| | | | following three |
| | | | ingredients to make |
| | | | slurry |
| Instant Yeast | 40-65 | 58 | |
| ParProAm | 0.0-1.0 | 0.1 | |
| Natax 2.2 | 5-15 | 10 | |
| | | | Mix slurry and above |
| | | | ingredients on low for |
| | | | 1 minute; then on |
| | | | high for 12 minutes |
| 2^{nd} Mix | | | |
| Flax Seed Meal | 130-150 | 140 | Add to mixer |
| Fibersol 2 | 70-100 | 88 | Add to mixer |
| Oat Fiber-1 | 70-100 | 80 | Add to mixer |
| (light) | | | |
| Slurry | | | Add water to the |
| | | | action gum to make |
| | | | slurry |
| Water | 150-200 | 185 | Add to ingrediator |
| Action gum | 0.0-1.0 | 0.0 | Add to mixer |
| | | | Mix slurry with 2^{nd} |
| | | | mix for 1 minute on |
| | | | low, then 10 minutes |
| | | | on high |
| 3^{rd} Mix | | | |
| Salt | 4-10 | 8 | Add to mixer |
| Water | 5-35 | 20 | Add to ingrediator |
| | | | Mix 3^{rd} mix on low |
| | | | for 30 seconds, then |
| | | | 3.5 minutes on high |

TABLE VII

| | Approximate | | |
|---|---|---|---|
| | Preferred | Approximate | |
| Ingredient | Range of | Preferred | |
| Name | Amount (lbs.) | Amount (lbs.) | Instruction |
| 1^{st} Mix | | | |
| Vital Wheat | 110-130 | 120 | Add to mixer |
| Gluten | | | |
| Vegetable Oil | 15-25 | 20 | Add to ingrediator; |
| | | | mix 2 minutes on low |
| Vinegar | 12-24 | 16 | Add to ingrediator |
| Glycerin | 0.0-1.0 | 0.0 | Add to ingrediator |
| Slurry | | | |
| Water | 175-225 | 205 | Add water to the |
| | | | following three |
| | | | ingredients to make |
| | | | slurry |
| Instant Yeast | 40-65 | 58 | |
| ParProAm | 0.0-1.0 | 0.1 | |
| Natax 2.2 | 5-1.5 | 10 | |
| | | | Mix slurry and above |
| | | | ingredients on low for |
| | | | 1 minute; then on |
| | | | high for 12 minutes |
| 2^{nd} Mix | | | |
| Flax Seed Meal | 65-75 | 70 | Add to mixer |
| Fibersol 2 | 70-100 | 88 | Add to mixer |
| Oat Fiber-1 | 70-100 | 80 | Add to mixer |
| (light) | | | |
| Whey Protein | 40-60 | 50 | Add to mixer |
| Isolate | | | |
| Baking Powder | 5-6.5 | 5.86 | Add to mixer |
| Slurry | | | Add water to the |
| | | | action gum to make |
| | | | slurry |
| Water | 150-200 | 185 | Add to ingrediator |
| Action gum | 0.0-1.0 | 0.0 | Add to mixer |
| Flax Seed Meal | 65-75 | 70 | Add to ingrediator |
| | | | Mix slurry with 2^{nd} |
| | | | mix for 1 minute on |
| | | | low, then 20 minutes |
| | | | on high |
| 3^{rd} Mix | | | |
| Salt | 4-10 | 8 | Add to mixer |
| Water | 5-15 | 20 | Add to ingrediator |
| | | | Mix 3^{rd} mix on low |
| | | | for 30 seconds, then |
| | | | 3.3 minutes on high |

In another alternative embodiment, the low-carbohydrate bakery item can be a low-carbohydrate biscuit. The ingredients present in the dough of the biscuit may include: vital wheat gluten, flax seed meal, soy protein flour, Fibersol® 2, dry sorbitol, baking powder, Soft N Mighty™, whey protein isolate, salt, gum, shortening, butter flavor, water, white vinegar, and glycerine. Alternatively, the dough of the biscuit can be made using a similar recipe as provided above for the English muffin. The method of manufacturing a dough for producing the low-carbohydrate biscuit may be similar to the step-wise method described in detail above.

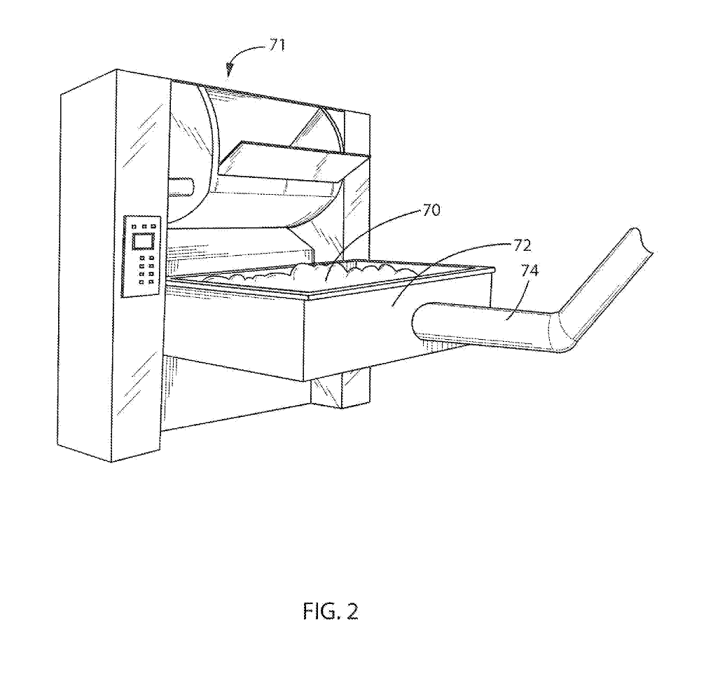

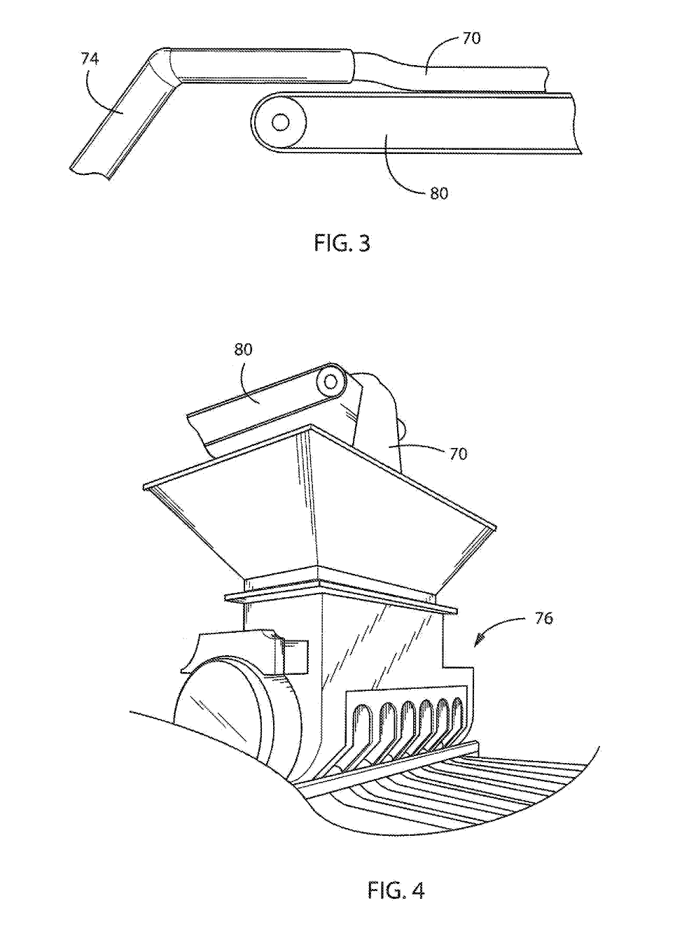

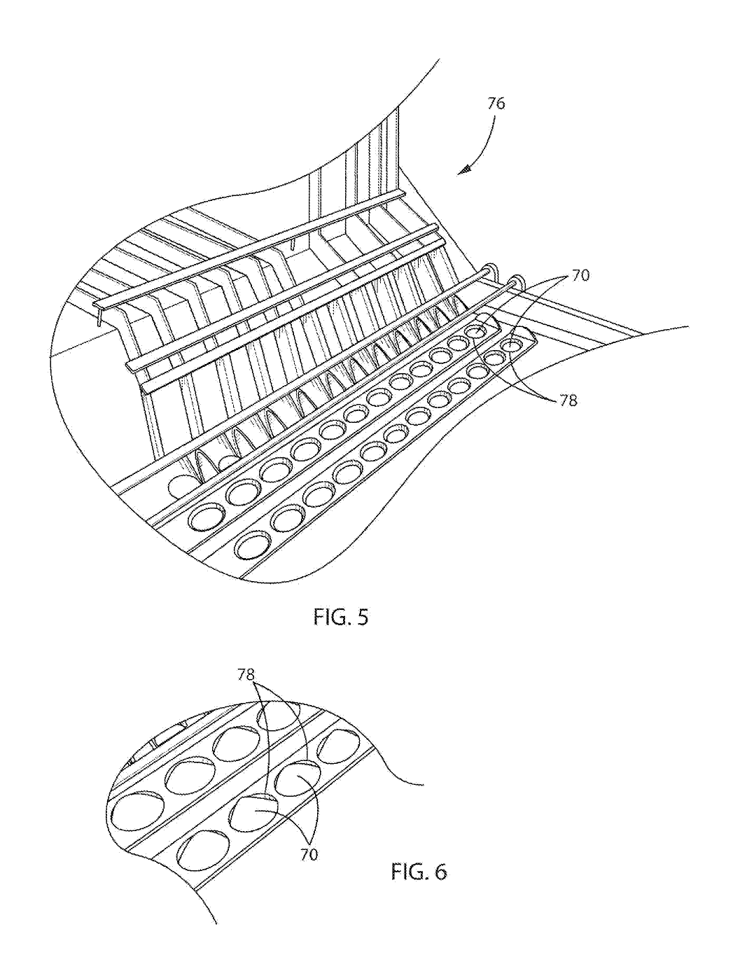

After the dough 70 is fully mixed, it is moved into a large container or vat 72 as shown in FIG. 2 where the dough 70 may rest. As the dough 70 rests, it expands. The vat 72 is attached to a dough pump 74 as shown in FIG. 3. At this point, the dough 70 should be flaccid and easy to pump. The dough 70 may need to be relaxed to reach the appropriate elasticity (50). The pump 74 takes the dough 70 from the vat 72, which serves as a large container where the dough 70 is spread out, and isolates the dough 70 into a linear configuration of dough 70 through the pump 74 (52). This results in the dough 70 being approximately the correct length and width. As shown in FIG. 3, the linear configuration of dough 70 is pumped onto a conveyor 80 that transports the dough. The conveyor 80 then delivers the dough 70 to a separator 76 as best seen in FIG. 4. The dough 70 can then be divided laterally to result in the appropriate height (54). For instance, this can be achieved using a Model K™ hopper dough separator 76, which divides the dough 70 that is structured in a line into the appropriate sized single portions of dough 70. These portions of dough 70 are next covered in cornmeal (56), and placed in a series of cups. FIG. 5 shows one configuration of the cups 78. Each individual portion of dough 70 fits into a single cup 78. These cups 78 are exposed to high heat and humidity for 30 minutes (58). These conditions result in the yeast being activated. As a result, the dough 70 rises slightly in preparation of the baking process as can best be seen in FIG. 6. After the dough 70 has risen slightly, it is ready for baking in the oven (60).

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

It is intended that the appended claims cover all such additions, modifications and rearrangements. Expedient embodiments of the present invention are differentiated by the appended claims.

What is claimed is:

1. A low carbohydrate bakery product, comprising:
a. a wheat gluten;
b. vegetable oil;
c. a glycerin;
d. water;
e. an instant yeast;
f. ParProAm;
g. Natax 2.2;
h. a flax seed meal;
i. a fiber;
j. an action gum;
k. salt;
l. a whey protein isolate;
m. a soy protein isolate; and
n. a baking powder.

2. The low carbohydrate bakery product of claim 1, wherein the fiber is oat fiber or Fibersol.

3. The low carbohydrate bakery product of claim 1, wherein the low carbohydrate bakery product is an English muffin.

4. The low carbohydrate bakery product of claim 1, wherein the low carbohydrate bakery product is a biscuit.

5. The low carbohydrate bakery product of claim 1, further comprising an oat flour.

6. A recipe for a low carbohydrate bakery product, comprising:
a. 120 parts vital wheat gluten
b. 20 parts vegetable oil
c. 16 parts vinegar
d. parts glycerin
e. 205 parts water
f. 58 parts instant yeast
g. 0.1 parts ParProAm
h. 10 parts Natax 2.2
i. 88 parts Fibersol 2
j. 80 parts oat fiber-1
k. 50 parts whey protein isolate
l. 5.86 parts baking powder
m. 185 parts water
n. parts action gum
o. 8 parts salt
p. 20 parts water, and
q. 140 parts flax seed meal.

7. The recipe for a low carbohydrate bakery product of claim 6, wherein ingredients a.-d. are initially placed into a industrial sized commercial bakery mixer, and ingredients e.-h. are initially placed in an ingrediator to create a slurry.

8. The recipe for a low carbohydrate bakery product of claim 7, wherein the slurry is piped into the industrial sized commercial bakery mixer, and the contents of the industrial sized commercial bakery mixer are initially mixed on a low setting for approximately one minute and then on a high setting for approximately twelve minutes.

9. The recipe for a low carbohydrate bakery product of claim 8, wherein ingredients i.-l. and half of ingredient q. are added to the industrial sized commercial bakery mixer, and ingredients m., n., and half of ingredient q. are initially placed in the ingrediator to create a slurry.

10. The recipe for a low carbohydrate bakery product of claim 8, wherein ingredients i.-l. and q. are added to the industrial sized commercial bakery mixer, and ingredients m., and n. are initially placed in the ingrediator to create a slurry.

11. The recipe for a low carbohydrate bakery product of claim 9, wherein the slurry is piped into the industrial sized commercial bakery mixer, and the contents of the industrial sized commercial bakery mixer are initially mixed on a low setting for approximately one minute and then on a high setting for approximately twenty minutes.

12. The recipe for a low carbohydrate bakery product of claim 11, wherein ingredients o. and p. are added to the industrial sized commercial bakery mixer, and the contents of the industrial sized commercial bakery mixer are initially mixed on a low setting for approximately 30 seconds and then on a high setting for approximately three and one half minutes.

13. The recipe for a low carbohydrate bakery product of claim 12, further comprising 40 parts oat flour.

14. The recipe for a low carbohydrate bakery product of claim 13, wherein 40 parts oat flour is added to the ingredients initially placed into the industrial sized commercial bakery mixer.

15. A method of manufacture of a low carbohydrate bakery product dough, comprising the steps of:
a. combining a first set of ingredients including a vital wheat gluten;
b. mixing a second set of ingredients including vegetable oil, a vinegar, and a glycerin;
c. combining the second set of ingredients with the first set of ingredients;
d. forming a first slurry from a third set of ingredients including water, an instant yeast, ParProAm and Natax 2.2;
e. mixing the first slurry into the first and second sets of ingredients at a second mixing speed greater than the first mixing speed for approximately twelve minutes to form an initial mixture;
f. adding a fourth set of ingredients including a flax seed meal, an oat fiber, whey protein isolate, baking powder, and an amount of Fibersol 2 to the initial mixture;
g. forming a second slurry from a volume of water, a volume of an action gum, and a volume of flax seed meal;
h. mixing the second slurry into the initial mixture and the fourth set of ingredients at the first mixing speed for approximately one minute;
i. mixing the second slurry into the initial mixture and fourth set of ingredients at the second mixing speed greater than the first mixing speed for approximately twenty minutes to form an intermediate mixture;
j. mixing a volume of salt and water into the intermediate mixture at the first mixing speed for approximately 30 seconds; and
k. mixing the volume of salt and water into the intermediate mixture at the second mixing speed for approximately 3.5 minutes to form the low carbohydrate bakery product dough.

16. The method of manufacture of a low carbohydrate bakery product of claim 15, further comprising the steps of
a. relaxing the dough in a vat such that the elasticity is appropriate to pass through a dough pump;
b. pumping the relaxed dough through the dough pump such that the dough is arranged in a straight line;
c. dividing the line of dough into individual portions using a dough separator;
d. covering the individual portions of dough in corn meal;
e. subjecting the dough to high heat and humidity to start yeast activation and fermentation; and
f. baking the dough in an oven.

17. The method of manufacture of a low carbohydrate bakery product of claim 15, wherein the dry ingredients are mixed in an industrial sized commercial bakery mixer.

18. The method of manufacture of a low carbohydrate bakery product of claim 17, wherein the wet ingredients are mixed in an ingrediator.

19. The method of manufacture of a low carbohydrate bakery product of claim 18, wherein the ingrediator is connected directly to the top of the industrial sized commercial bakery mixer.

20. The method of manufacture of a low carbohydrate bakery product of claim 15, further comprising an oat flour that is mixed with the first set of ingredients.
